(19) United States
(12) Patent Application Publication
(10) Pub. No.: US 2002/0059524 A1
(43) Pub. Date: May 16, 2002

(54) Encoder, decoder, data processing apparatus, network system, data processing method, recording medium, and program

(75) Inventor: Hiroki Takeshita, Tokyo (JP)

Correspondence Address: Connolly Bove Lodge & Hutz LLP, Suite 800, 1990 M Street, N.W., Washington, DC, 20036-3425, US

(73) Assignee: NS Solutions Corporation, Tokyo (JP)

(21) Appl. No.: 09/905,889

(22) Filed: Jul. 17, 2001

(30) Foreign Application Priority Data
Jul. 18, 2000 (JP) 2000-217755
Jul. 10, 2000 (JP) 2001-209518

(51) Int. Cl. G06F 11/30

(52) U.S. Cl. 713/200

(57) ABSTRACT

A network system is provided which can surely prevent data to be protected from being taken out by unauthorized outside accesses or users. A file server stores in a database a result (encode data d2) of encoding data d0 to be protected using first data d1 having a definite rule and second data α. A monitor server monitors data on a communication line and when the first data d1 is obtained from data X using the second data α and the definite rule which the first data d1 has can be detected based on a result of analyzing it when the data X is decoded, it recognizes that the data X is the encode data d2 and performs processing for interrupting communication or the like.

### CROSS-REFERENCE TO RELATED APPLICATIONS

This application is based upon and claims priority of Japanese Patent Application Nos. 2000-217755 and 2001-209518, filed on Jul. 18, 2000 and Jul. 10, 2001, the contents being incorporated herein by reference.

### BACKGROUND OF THE INVENTION

1. [Field of the Invention]

The present invention relates to encoders, decoders, data processing apparatus, network systems, and data processing methods used in equipment or systems for protecting data in network systems in which, for example, a plurality of computers and so on are connected on a network, and computer-readable recording media recording thereon programs for causing computers to execute processing steps to carry out the above, and the program.

2. [Description of the Related Art]

In recent years, in network systems used in business organizations and so on, the following methods (1) to (4) are used as methods for protecting data in the systems against external accesses.

(1) A method of restricting accesses to a system or a file by checking a password input from a user or by existence of a right which is determined for each user.

(2) Encoding of data.

(3) A method of monitoring whether or not, for example, a specific character string which is preset as confidential information is included in data on a network (a communication line) and interrupting communication when the specific character string is detected, as a cracking detecting method (an invasion detecting method) for preventing external unjust invasion.

According to the method (3), for example, in a network system of a business organization, various data inside the business organization such as personnel data and customer data including the specific character string can be prevented from flowing outside the system.

(4) A method of monitoring an access whether or not it is an access by a specific communication protocol (an unauthorized communication protocol and so on) and restricting the access when it is an access by the specific communication protocol, as a so-called fire wall function.

However, the conventional data protecting methods (1) to (4) as described above have the following disadvantages.

(Disadvantage 1)

In the method (1) of restricting an access to a system or a file by a password and so on, there is a danger that, for example, once the password is broken through, all data in the system becomes accessible.

(Disadvantage 2)

In the method (2) which uses encoding of data, even if the data flows outside, the original data thereof can be protected at that time since the data is encoded, but the encoded data can be decoded before long.

(Disadvantage 3)

In the method (3) of monitoring data on a communication line (a network) to detect a specific character string from the data, as for data whose volume is large and whose contents change frequently such as customers' account numbers and account balances managed inside banks, and personnel data or technology method data of business organizations, it is complicated to set the specific character string and it is very difficult to detect it.

(Disadvantage 4)

In the method (4) of monitoring a specific communication protocol, there is a danger that an access by using communication protocols other than that protocol cannot be prevented.

### SUMMARY OF THE INVENTION

It is an object of the present invention to provide encoders, decoders, data processing apparatus, network systems, and data processing methods which can surely prevent data to be protected from being taken out by an unauthorized external access or user by the configuration in which mark data is added to object data in advance and communication is interrupted based on the detection of the mark data, and computer readable recording media recording thereon programs for causing computers to execute processing steps for carrying out the above, and the program.

According to the first aspect of the present invention, an encoder for encoding object data d0 by using first data d1 having a definite rule and predetermined second data α, comprises means for performing encoding so that the definite rule is detectable, when encode data d2 of the object data d0, which is obtained from encoding, is decoded, based on a result of analyzing the first data d1 obtained from the encode data d2 by using the second data α.

According to the second aspect of the present invention, in the first aspect, the first data d1 includes data which is obtained by computing an optional function having a predetermined parameter ω.

According to the third aspect of the present invention, in the first aspect, encoding is performed so that the encode data d2 is obtained by computation for inserting the first data d1 to the object data d0 in a unit of bit using the second data α.

According to the fourth aspect of the present invention, in the first aspect, the first data d1 includes data which is obtained using orthogonal functions and is capable of taking different values even with the same parameter.

According to the fifth aspect of the present invention, a decoder for decoding encode data d2 of object data d0 which is encoded by using first data d1 having a definite rule and predetermined second data α, comprises obtaining means for obtaining the first data d1 from the encode data d2 using the second data α and detecting means for detecting the definite rule by analyzing the first data d1 which is obtained by the obtaining means.

According to the sixth aspect of the present invention, in the fifth aspect, the first data d1 includes data which is obtained by computing an optional function having a predetermined parameter ω as the definite rule and the detecting means detects the predetermined parameter ω.

According to the seventh aspect of the present invention, in the fifth aspect, decoding is performed so that the object data d0 and the first data d1 are obtained by extracting a part from the encode data d2 in a unit of bit using the second data α.

According to the eighth aspect of the present invention, in the fifth aspect, the first data d1 includes data which is obtained using orthogonal functions and is capable of taking different values even with the same parameter.

According to the ninth aspect of the present invention, a data processing apparatus for monitoring data output from storing means which stores at least encode data d2 of object data d0 which is encoded using first data d1 having a definite rule and predetermined second data α, comprises detecting means for detecting the definite rule from data sent out from the storing means by obtaining the first data d1 from the encode data d2 by using the second data α to analyze the first data d1 and processing means for performing a predetermined process to the output of the encode data d2 based on a result of the detection by the detecting means.

According to the tenth aspect of the present invention, in the ninth aspect, when the definite rule is detected, the predetermined process includes at least one of a process of interrupting a communication line, which is connected to the storing means, for outputting data and a process of notifying the detection.

According to the eleventh aspect of the present invention, a recording medium recording thereon an encoded result of data d0, which has been encoded by an encoding function, so that the result can be sent out to a communication line, the function being for encoding optional data d0 using first data d1 having a definite rule and predetermined second data α, and being capable of detecting the definite rule on the basis of a result of an analysis of the first data d1 obtained from encode data d2 using the second data α, when the encode data d2 of the data d0, which is obtained by encoding, is decoded.

According to the twelfth aspect of the present invention, a network system comprises a plurality of devices which are connected to communicate with each other via a network, wherein at least one of the devices is a device for performing encoding object data d0 using first data d1 having a definite rule and predetermined second data α, and comprises means for performing encoding so that the definite rule is detectable, when encode data d2 of the object data d0, which is obtained by encoding is decoded, based on a result of analyzing the first data d1 obtained from the encode data d2 using the second data α.

According to the thirteenth aspect of the present invention, a network system comprises a plurality of devices which are connected to communicate with each other via a network, wherein at least one of the devices is a device for decoding encode data d2 of object data d0 which is encoded using first data d1 having a definite rule and predetermined second data a, and comprises obtaining means for obtaining the first data d1 from the encode data d2 using the second data α and detecting means for detecting the definite rule by analyzing the first data d1 which is obtained by the obtaining means.

According to the fourteenth aspect of the present invention, a network system comprising a plurality of devices which are connected to communicate with each other via a network, wherein at least one of the devices is a device comprising a recording medium recording thereon an encoded result of data d0, which has been encoded by an encoding function, so that the result can be sent out to a communication line, the function being for encoding optional data d0 using first data d1 having a definite rule and predetermined second data α, and being capable of detecting the definite rule on the basis of a result of an analysis of the first data d1 obtained from encode data d2 using the second data α, when the encode data d2 of the data d0, which is obtained by encoding, is decoded.

According to the fifteenth aspect of the present invention, a data processing method for monitoring data on a communication line to which at least storing means for storing optional data is connected, comprises the steps of encoding predetermined object data d0 using first data d1 having a definite rule and predetermined second data α and storing in the storing means encode data d2 of the object data d0, which is obtained in the step of encoding, wherein the step of encoding includes the step of performing encoding so that the definite rule is detectable, when the encode data d2 is decoded, based on a result of analyzing the first data d1 which is obtained from the encode data d2 using the second data α.

According to the sixteenth aspect of the present invention, in the fifteenth aspect, it further comprises the step of decoding the data on the communication line in sequence using the second data α, wherein the step of decoding comprises the steps of obtaining the first data d1 from the object data on the communication line using the second data α and detecting the definite rule by analyzing the first data d1 which is obtained in the step of obtaining.

According to the seventeenth aspect of the present invention, in the sixteenth aspect, it further comprises the step of performing a predetermined process based on a detection result in the step of detection.

According to the eighteenth aspect of the present invention, in the seventeenth aspect, when the definite rule is detected, the predetermined process comprises at least one of a process of interrupting communication and a process of notifying the detection.

According to the nineteenth aspect of the present invention, a computer-readable recording medium records thereon a program for causing a computer to realize a function of monitoring data on a communication line to which at least storing means for storing optional data is connected, wherein the program causes the computer to execute a processing step which includes the steps of encoding predetermined object data d0 using first data d1 having a definite rule and predetermined second data α and storing in the storing means encode data d2 of the object data d0, which is obtained in the step of encoding, and wherein the step of encoding includes the step of performing encoding so that the definite rule is detectable, when the encode data d2 is decoded, based on a result of analyzing the first data d1 obtained from the encode data d2 using the second data α.

According to the twentieth aspect of the present invention, a computer-readable recording medium records thereon a program for causing a computer to realize a function of encoding object data d0 using first data d1 having a definite rule and predetermined second data α, wherein the program causes the computer to realize a function of performing encoding so that the definite rule is detectable, when encode data d2 of the object data d0, which is obtained by encoding is decoded, based on a result of analyzing the first data d1 obtained from the encode data d2 using the second data α.

According to the twenty-first aspect of the present invention, a computer-readable recording medium records thereon a program for causing a computer to realize a function of decoding encode data d2 of object data d0 which is encoded using first data d1 having a definite rule and predetermined second data α, wherein the program causes the computer to realize a function of detecting the definite rule by obtaining the first data d1 from the encode data d2 by using the second data α to analyze the first data d1.

According to the twenty-second aspect of the present invention, a program product for causing a computer to realize a function of monitoring data on a communication line to which at least storing means for storing optional data is connected, causes the computer to realize a processing step which includes the steps of encoding predetermined object data d0 using first data d1 having a definite rule and predetermined second data α and storing in the storing means encode data d2 of the object data d0, which is obtained in the step of encoding, wherein the step of encoding includes the step of performing encoding so that the definite rule is detectable, when the encode data d2 is decoded, based on a result of analyzing the first data d1 which is obtained from the encode data d2 using the second data α.

According to the twenty-third aspect of the present invention, a program product for causing a computer to realize a function of encoding object data d0 using first data d1 having a definite rule and predetermined second data α, causes the computer to realize a function of performing encoding so that the definite rule is detectable, when encode data d2 of the object data d0, which is obtained by encoding, is decoded, based on a result of analyzing the first data d1 obtained from the encode data d2 using the second data α.

According to the twenty-fourth aspect of the present invention, a program product for causing a computer to realize a function of decoding encode data d2 of object data d0 which is encoded using first data d1 having a definite rule and predetermined second data α, causes the computer to realize a function of detecting the definite rule by obtaining the first data d1 from the encode data d2 by using the second data α to analyze the first data d1.

### BRIEF DESCRIPTION OF THE DRAWINGS

FIG. 1 is a block diagram showing the construction of a network system according to the first embodiment of the present invention;

FIG. 2 is a flowchart showing operations of a file server and a monitor server of the network system;

FIG. 3 shows an example of a format of encode data which flows on a network of the network system;

FIG. 4 shows an example of interrupting communication on the network by the monitor server;

FIG. 5 shows encode processing in a file server according to the second embodiment of the present invention; and

FIG. 6 is a flowchart showing an operation of a monitor server according to the second embodiment.

### DETAILED DESCRIPTION OF THE PREFERRED EMBODIMENTS

Embodiments of the present invention will be described below with reference to the accompanying drawings.

First Embodiment

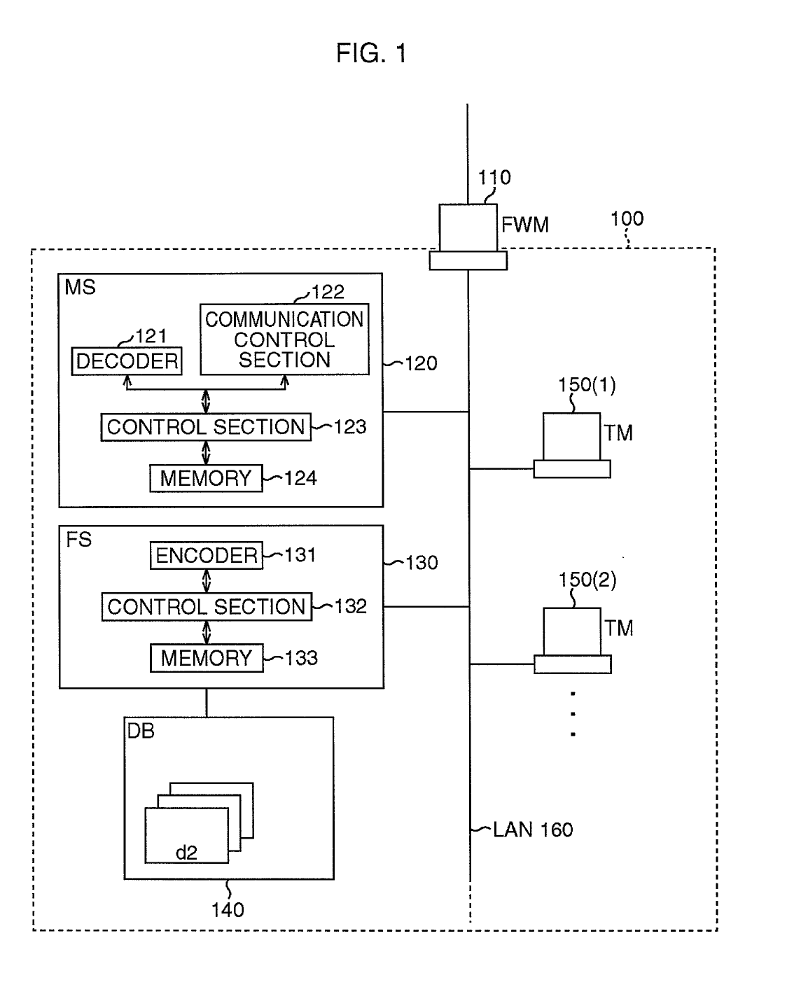

The present invention is applied, for example, to a network system 100 as shown in FIG. 1.

As shown in FIG. 1, the network system 100 has a construction in which a fire wall machine (FWM) 110, a monitor server (MS) 120, a file server (FS) 130, and terminal machines (TM) 150(1), 150(2), . . . are connected on a network 160 such as a LAN (supposed to be a ‘LAN’ here).

The monitor server 120, which monitors particularly data on the LAN 160, includes a decoder 121 for decoding encode data d2 on the LAN 160, which will be described later, a communication control section 122 for controlling communication on the LAN 160, a control section (a CPU and so on) 123 for controlling operation of the entire monitor server 120, a memory 124 for storing a processing program for controlling operation by the control section 123, various kinds of data, and so on.

The file server 130 includes an encoder 131 for encoding input data (important personal data and so on, hereinafter referred to also as ‘original data d0’), a control section (a CPU and so on) 132 for controlling operation of the entire file server 130, and a memory 133 for storing a processing program for the operation control by the control section 132, various kinds of data, and so on.

To the file server 130, a database 140 is also connected and in the database 140, data after being encoded by the encoder 131 (the encode data d2) is stored.

The terminal machines (TM) 150(1), 150(2) . . . are composed of computers and so on including CPUs, memories, and so on to be able to access the database 140 of the file server 130.

Incidentally, functions of the decoder 121 and the communication control section 122 of the monitor server 120 may be carried out by hardware or software (carried out in a manner that the control section 123 reads a predetermined processing program from the memory 124 and so on).

A function of the encoder 131 of the file server 130 may also be carried out by hardware or software (carried out in a manner that the control section 132 reads a predetermined processing program from the memory 133).

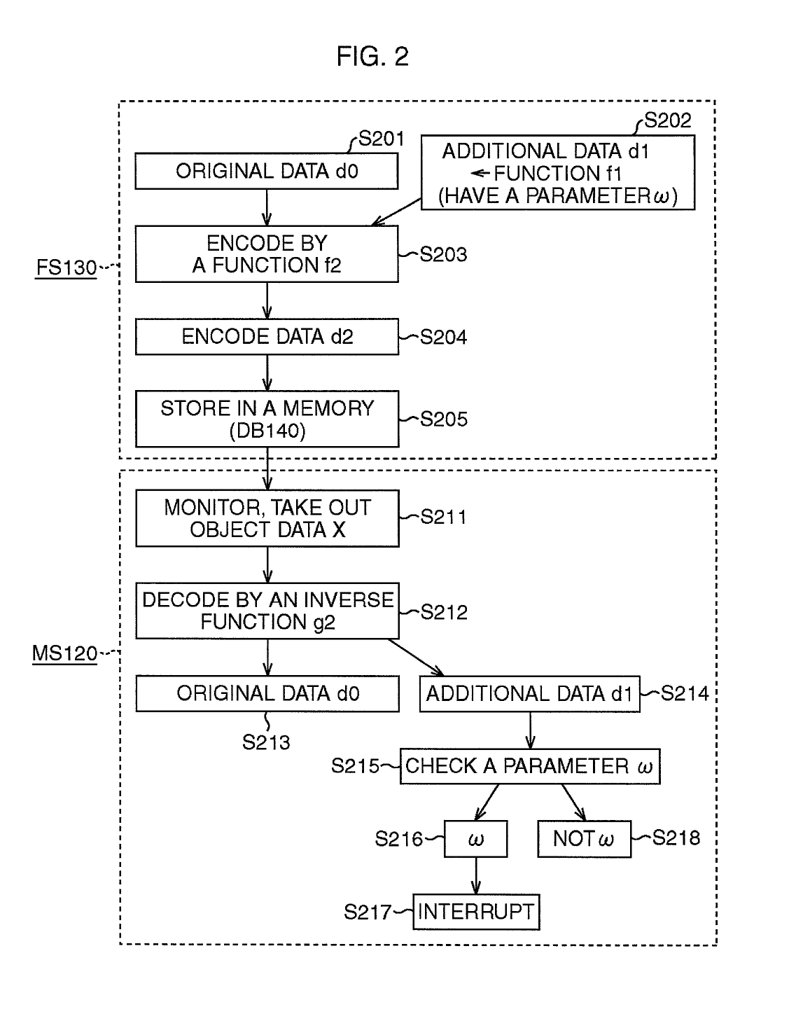

Here, in the network system 100 according to this embodiment, particularly the file server 130 executes processing of steps S201 to S205 as shown in FIG. 2 to generate the data d2 which is made by adding mark data to the original data (important data to be kept confidential and so on) d0 and store it in the database 140. The monitor server 120 executes steps S211 to S218 as shown in FIG. 2 to monitor the data which flows on the LAN 160 and communication is interrupted when the mark data is detected from the data. This operation will be described below more specifically.

Here, when the data is to be encoded in the file server 130, a user uses a recording medium such as a floppy disk where the original data d0, which is data to be protected, is recorded, and a disc driver disposed in the file server 130 reads recorded data (the original data d0) on the recording medium to encode it.

Incidentally, the original data d0 may be stored in the database 140, for example, after the user of the terminal machine (TM) in the network system 100 encodes the original data d0 by an encoder disposed in the terminal machine (TM) and transmits it to the file server 130.

Step S201:

In the file server 130, the encoder 131 designates the data to be protected as the original data d0.

Step S202:

The encoder 131 generates additional data d1 having a definite rule.

More specifically, data which is obtained by computing a function f1 having a parameter ω is designated as the additional data d1. As for the function f1, the parameter ω is obtained after computing and analyzing the data d1, which is a computation value of the function f1, by a function g1 of the function f1.

Incidentally, as for the function f1, the parameter ω may be obtained by inverse computation.

Step S203 and Step S204:

The encoder 131 encodes the original data d0 with an optional function f2 (step S203) using the additional data d1 and key data α and obtains the encode data d2 (step S204).

As for the function f2, the original data d0 and the additional data d1 are obtained after computing the data d2, which is a computation value of the function f2 by an inverse function g2 of the function f2 using the key data α.

Step S205:

The control section 132 stores in the database 140 the encode data d2 which is obtained in the encoder 131.

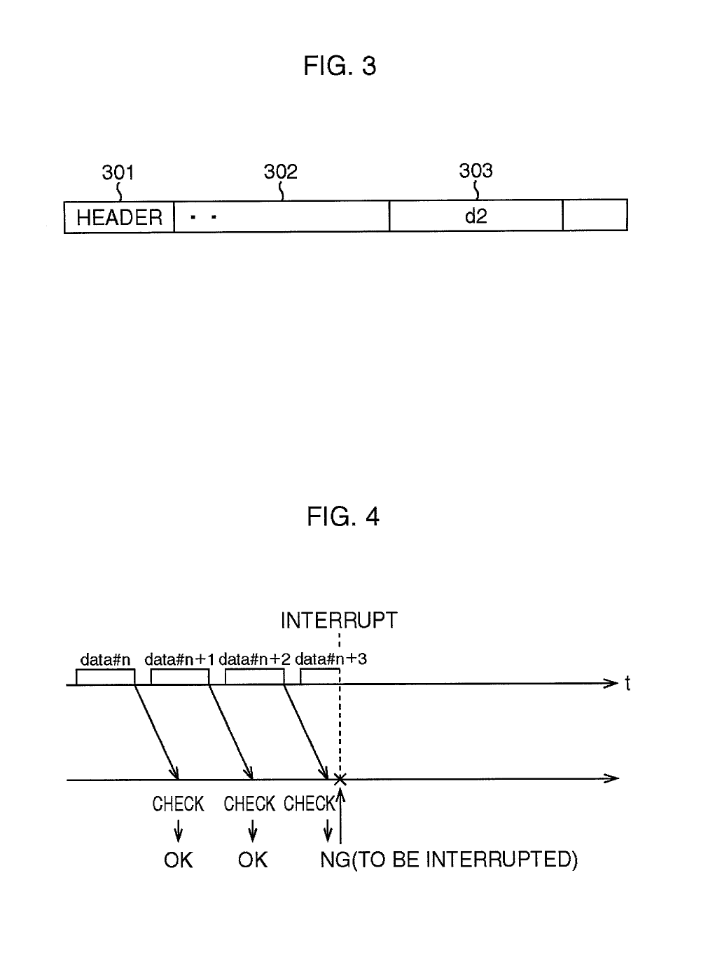

When the encode data d2 in the database 140 is sent out to the LAN 160, for example, as shown in FIG. 3, the encode data d2 is sent out following a header section 301, which includes information and so on about a transmitting party and a transmission destination, and a data section 302, which includes certified data and so on.

According to processing of the steps S201 to S205 as described above, the encode data d2 in the database 140 can be separated into the original data d0 and the additional data d1 through the inverse computation by the inverse function g2, and the additional data d1 has a rule (the computation value of the function f1 having the parameter ω). In other words, when certain data X can be separated into the original data d0 and the additional data d1 through the inverse computation by the inverse function g2 and the additional data d1 has the rule (the computation value of the function f1 having the parameter ω) , the data X is the encode data d2 (the encoded data to be protected) which is stored in the database 140.

Step S211:

In the monitor server 120, the communication control section 122 takes out the data flowing on the LAN 160 in sequence for monitoring.

Steps S212 to S214:

The decoder 121 decodes object data (hereinafter referred to as the ‘data X’) with the inverse function g2 of the function f2 using the key data α (step S212) to obtain the original data d0 and the additional data d1 (step S213 and step S214).

Incidentally, at this time, when the additional data d1, among the original data d0 and the additional data d1 obtained from the data X, does not have the rule (when the additional data d1 is not the computation value of the function f1 having the parameter ω), the data X is considered as the data not to be protected, and therefore, processing returns to step S211 to process next data (X+1).

Step S215:

The control section 123 analyzes the data d1 which is obtained in the decoder 121 and checks whether the data d1 has the rule (the computation value of the function f1 having the parameter ω) or not.

Step S216 and Step S217:

When a result of checking in the step S215 shows that the data d1 has the rule, the control section 123 recognizes that the data X is the data d2 which is stored in the database 140, that is, the encode data d2 obtained after encoding the original data d0 to be protected, and interrupts communication on the LAN 160 via the communication control section 122.

FIG. 4 shows an example of timing for the communication interruption when data in a data format as shown in FIG. 3 (message data) is flowing on the LAN 160.

First, data checking by processing in the steps starting from step S211 as described above is performed for the data starting from data #n (X=n) in sequence and when the data d1 of data #n+3 following data #n+2 is judged to have the rule, the flow of the data #n+3 on the LAN 160 is interrupted.

Incidentally, instead of interrupting the communication in the step S217, it is also suitable that, for example, a part of the message data is checked and when it is within a permissible range set in advance (a specific user, terminal machine, system and so on), the data X is sent out and its outputting to other ranges is interrupted.

It is also suitable that in the case where the original data is encoded in the terminal machine (TM) to be registered in the database 140 of the file server 130 as described above, if its destination is the file server 130, it is considered to be within a permissible range and therefore, the communication is not interrupted even when the encoded data is transmitted to the file server 130 from the terminal machine (TM).

Step S218:

When a result of checking in step S215 shows that the data d1 does not have the rule, the data X is not the data d2 which is stored in the database 140 and is not to be protected, and therefore, processing returns to step S211 to process the next data (X+1).

The construction according to this embodiment as described above can surely prevent the encode data d2 (the data to be protected) in the database 140 from being taken out unjustly outside the network system 100 via the LAN 160. Inside the network system 100, it can also surely prevent unjust reading, obtaining, and so on of the encode data d2 in the database 140 by an unauthorized user.

Second Embodiment

In this embodiment, the first embodiment is further made specific.

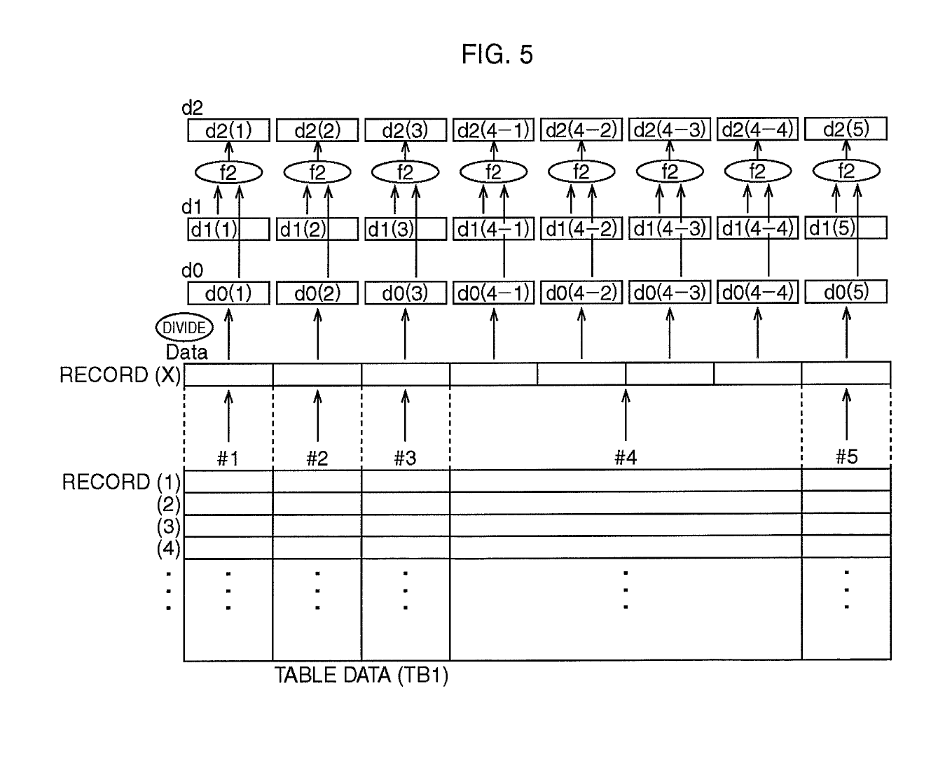

FIG. 5 shows how original data d0 is converted (encoded) to generate encode data d2 in this embodiment.

The original data d0 here is supposed to be obtained from table data TB1 which includes important data to be kept confidential such as customers' account numbers and so on in a bank.

More specifically, the table data TB1 includes a plurality of records (1), (2), (3), (4), . . . and each of these records (1), (2), (3), (4), . . . includes data of fields #1 to #5.

Note an optional record (X) out of the records (1), (2), (3), (4), . . . here. Each of the data of the fields #1 to #5 in the record (X) is divided into data segments with a predetermined length. To simplify the explanation, in FIG. 5, the fields #1 to #3 and #5 are supposed to be 8 bits in data length and the field #4 is supposed to be 32 bits in data length, and the length of the divided segments is supposed to be 8 bits. The divided data is taken as the original data d0. Therefore, original data d0(1) is obtained from the field #1, original data d0(2) is obtained from the field #2, original data d0(3) is obtained from the field #3, original data d0(4-1), d0(4-2), d0(4-3), and d0(4-4) are obtained from the field #4, and original data d0(5) is obtained from the field #5.

Note that the segment length is supposed to be 8 bits here to simplify the explanation, though a normal segment length is 512 bits and so on.

Each of the original data d0(1) to d0(5) which is thus obtained is to be encoded as described in the first embodiment (processing by the encoder 131 of the file server 130) and in this embodiment, processing of encoding is made more specific.

The following explanation notes the original data d0(1) to explain processing which ends with obtaining encode data d2(1) from the original data d0(1). Processing for the other original data d0(2) to d0(S) is the same with that for the original data d0(1) and therefore, the explanations thereof are omitted.

The following explanations are given with reference to FIG. 1 and FIG. 2.

Step S201:

The encoder 131 generates the original data d0(1) in the file server 130 in a manner as described above.

Step S202:

The encoder 131 generates additional data d1(1) having a definite rule. For example, a function f1 having a parameter ω is supposed to be a function as expressed by the following formula.

sin (ωx+θ)

This function value (sine wave data) is supposed to be additional data d1.

Note that the additional data d1 is supposed to have the same data length, 8 bits, as the data length of the original data d0(1) to simplify the explanation here.

In the above formula, ‘x’ takes each value, ‘n, n +1, . . . , n+K’ in sequence.

Here, ‘K’ indicates the number of points on the sine wave with which the sine wave can be specified and it is defined as follows.

For example, when the additional data d1 is 512 bits and n and K are expressed as n=1 and K=63 respectively, sin (ωx+θ) is computed with x taking values x=1, 2, 3, . . . , 64 for every 8 bits unit of the additional data d1 (=512 bits/64). Here, ‘θ’ is fixed. As a result, 64 data can be obtained for x−1, 2, 3, . . . , 64. The 64 data respectively indicate amplitude at 64 points on the sine wave, which is expressed as sin (ωx+θ). Therefore, in this case, data in which the 64 data is permutated becomes the additional data d1.

‘To permutate’ here means to arrange data in sequence to make a series of data.

θ is an optional number which is generated at random for each original data d0(1), (2), . . . to be processed.

Therefore, the function f1 has the parameter ω as a constant and the parameter ω can be specified through inverse computation by an inverse function g1 of the function f1 and by analyzing the result.

Step S203 and Step S204:

The encoder 131 encodes the original data d0(1) based on a predetermined rule (a function f2) using the additional data d1 (step S203) and obtains encode the data d2(1) (step S204).

As the predetermined rule, a rule using data (key data) α with the same data length, 8 bits, with that of the original data d0(1) and the additional data d1 is utilized. More specifically, when object bit data of the key data α is ‘0’, corresponding bit data of the additional data d1 is inserted before corresponding bit data of the original data d0(1), and when it is ‘1’, the corresponding bit data of the additional data d1 is inserted after the corresponding bit data of the original data d0(1).

Therefore, for example, when the original data d0(1), the additional data d1, and the key data α are supposed to be as follows respectively,

d0(1): 10110010

d1: 01101101

α: 01010010

the encode data d2(1) becomes as follows.

d2(1): 0101111010101010

In this way, the original data d0(1) with 8 bits is converted into data d2(1) (the encode data) with 16 bits by the predetermined rule. The correlation between the original data d0(1) and the encode data d2(1) is expressed by the following formula.

d2(1)=f(d0(1), d1, α)

Step S205:

The control section 132 stores in the database 140 the encode data d2(1) which is obtained in the encoder 131.

Processing of steps S201 to S205 as described above is executed for all original data d0(X) which is obtained from the table data TB1 as shown in FIG. 5.

Since all encode data d2(X) stored in the database 140 is important data, only a user who is authorized to access the data can see data contents.

For this purpose, a terminal machine 150(X) of the user who has an access right has a decode function (the same function with that of the decoder 121 of the monitor server 120) for decoding the encode data d2(X).

The decode function of the terminal machine 150(X) is carried out by an algorithm which is inverse to an algorithm of encoding the original data d0(X) (hereinafter referred to as an ‘inverse computation algorithm’) as described above.

More specifically, the inverse computation algorithm here is performed so that the encode data d2(X) can be separated into the data d1 and the data d0 (X) using key data α(X) and it can be regenerated by synthesizing, separating, and so on the segments of the data d0(X) (the original data d0(X)) as column data.

For example, when a user of the terminal machine 150(1) is a user whose access is authorized, the user operates the terminal machine 150(1) to have the terminal machine 150(1) access the database 140 so that the encode data d2(X) in the database 140 is taken in the terminal machine 150(1) via the LAN 160.

A processing program based on the inverse computation algorithm (the inverse computation algorithm using the key data α) is stored in a memory (not shown) in the terminal machine 150(1) in advance. Thereby, a CPU (not shown) reads and executes the processing program in the memory in the terminal machine 150(1) so that the encode data d2(X) is decoded.

Note that the decode function by the inverse computation algorithm in the terminal machine 150(X) is the same as the function of the decoder 121 of the monitor server 120 which will be described later and therefore, the detailed explanation thereof is omitted here.

The inverse computation algorithm in the terminal machine 150(X) is not limited to the construction in which it is carried out by software, but it may be carried out by hardware, firmware and so on.

Here, when a user whose access is not authorized tries to access the database 140 to take out the encode data d2(X) by some means or a user who invades through the fire wall machine 110 from outside the network system 100 tries to access the database 140 to take out the encode data d2(X), the encode data d2(X) must be surely protected.

In this embodiment, the original data d0(X) to be protected is also encoded and converted into the encode data d2(X) and the monitor server 120 monitors the data on the LAN 160 to interrupt communication if necessary in a similar manner to the first embodiment so that the encode data d2(X) in the database 140 can surely be prevented from being taken out unjustly.

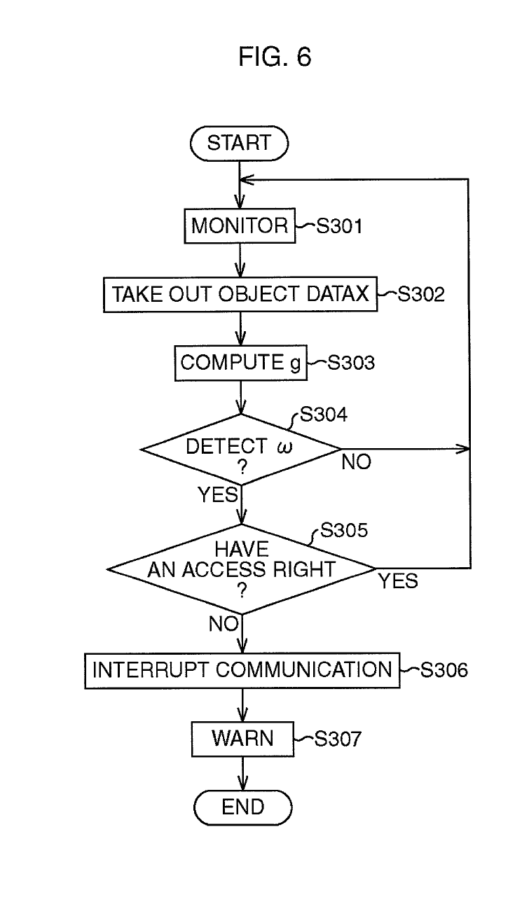

FIG. 6 shows the operation of the monitor server 120 according to this embodiment.

Incidentally, the operations shown in FIG. 6 are realized by applying the operations of steps S211 to S217 in FIG. 2 to this embodiment and making them more specific.

Step S301 and Step S302:

The communication control section 122 monitors the data which flows on the LAN 160 (step S301) and takes out the object data (the data X) (step S303).

The object data X here has the same data length as that of the encode data d2(X).

Step S303:

The decoder 121 decodes the object data X by the inverse computation algorithm (g) as described above. Then, the decoder 121 analyzes the data d1 (analyzes waveform data) which is obtained by decoding and obtains the parameter ω of the function f1 (=sin (ωx+θ)) which is used in generating the data d1.

Note that, at this time, the data X is considered to be data not to be protected when the parameter ω is not obtained by the inverse computation algorithm, and processing returns to step S301 to process next data (X+1).

Step S304:

The control section 123 judges whether the parameter ω which is obtained in the decoder 121 has a predetermined value or not.

When the result of this judgment shows that the parameter ω does not have the predetermined value, the data X is not the encode data d2(X) which is stored in the database 140 and is data not to be protected, and therefore, processing returns to step S301 to process the next data (X+1).

Step S305:

When the result of step S304 shows that the parameter ω has the predetermined value, the control section 123 recognizes that the data X is the encode data d2(X) which is stored in the database 140, that is, the encode data d2(X) which is obtained after the original data d0(X) to be protected is encoded, and discriminates the existence of an access right.

As a method of discriminating the existence of the access right, various methods can be considered. For example, such a method is available where the nonexistence of the access right is discriminated, when the data X is transmitted to the unauthorized user, by referring to information on the authorized user which is stored in advance in the memory 124 and information on a transmission destination which is included in the header section (refer to FIG. 3) and so on of the data X.

When the result of the discrimination shows the existence of the access right, processing returns to step S301 to process the next data (X+1).

Step S306:

When the result of the discrimination in step S305 shows the nonexistence of the access right, the control section 123 interrupts the communication on the LAN 160 via the communication control section 122.

As a method of interrupting the communication, for example, the following methods (1) and (2) can be considered.

(1) To cut off power source of a router by a control signal from a different signal line.

(2) To provide equipment for electrically interrupting the communication on the LAN 160 and to control the equipment.

Step S307:

The control section 123 gives a warning to the user and so on of the transmission destination.

Incidentally, in the first and second embodiments, for example, the following construction is also suitable.

Other Embodiment 1

The original data d0 is, for example, compressed, encoded, and so on to generate original data d0′ and the original data d0′ is encoded to generate encode data d2′. The encode data d2′ may also be converted by computing and processing the function a plurality of times.

Other Embodiment 2

The data length (the segment length) is not limited to a fixed length of 8 bits when the original data d0 is generated (refer to FIG. 5). For example, it may be a length variable for each record (X), each table data, or each file. In this case, a value of the key data α should be also variable together with this.

Other Embodiment 3

The data lengths of the original data d0 and the additional data d1 are made different from each other.

Other Embodiment 4

The value of the key data α is not limited to the fixed value. For example, it may be variable for each table data and each file. Units of key data α1, α2, . . . may be used in one table data. The units of key data α1, α2, . . . may be changed periodically for use. A single unit of key data α may be used in one system.

Other Embodiment 5

Instead of the sine wave function (sin (ωx+θ)) which is used when the additional data d1 is generated in the second embodiment, for example, a function which is expressed as follows is used.

A1 sin (Ω1x+θ1)+A2 cos (Ω2x+θ2)+ . . .

Here, each of the θ1, θ2, . . . is a fixed value and may take a random value for each data segment.

In this case, the parameters ω correspond to ((Ω1, A1), (Ω2, A2), . . . ), and when the parameters ωare obtained, it is judged that the data to be protected (the encode data d2) is flowing on the LAN 160.

Other Embodiment 6

As the function used when the additional data d1 is generated, an optional function can be applied and it may be any function as long as it can detect a predetermined parameter by the analysis.

Other Embodiment 7

Units of key data α1, α2, . . . are used, parameters ω1, ω2, . . . are matched with them, and based on the contents of the data to be protected, it is encoded by the combination of key data αx and the parameter ωx. For example, the following definition is made in advance.

α1: data not to be taken outside the system

α2: data which can be referred to only by an authorized user in the system

α3: data which can be referred to by a user outside the system if he/she has an access right

Then, using the key data αx based on the contents of the data to be protected, it is encoded.

In decoding, the data X to be decoded is first decoded using the key data α1, and when the parameter ω1 is obtained as a result, the data X is recognized as the ‘data not to be taken outside the system’ and processing such as interrupting the communication is performed.

When the parameter ω1 is not obtained, decoding is then performed using the key data α2, and when the parameter ω2 is obtained as a result, the data X is recognized as the 'data which can be referred to only by an authorized user in the system. Then, the transmission destination of the data X is checked, and based on the result, processing of interrupting the communication and so on is performed.

The units of data α1, α2, . . . are used to perform decoding in sequence and the results are analyzed in this way so that the contents of the data X are recognized and the corresponding process is carried out.

Other Embodiment 8

The function to be used for encoding in the other embodiment 7 is replaced by the same function having the plurality of parameters ω1, ω2, . . . with that in the other embodiment 5.

In this case, since the parameters ω1, ω2, . . . correspond to the key data α1, α2, . . . respectively, for example, when the data X to be decoded is decoded using the key data α1, the data X is recognized as the ‘data not to be taken outside the system’ if all the parameters ω1, ω2, . . . are obtained.

Other Embodiment 9

Only part of the data to be protected (part of the table data and the file) is encoded. For example, in the table data TB1 as shown in FIG. 5, only a field #X (a field where the password is stored and so on) may be encoded.

Other Embodiment 10

The object of the present invention is of course achieved when the recording medium recording thereon a program code of software, which realizes functions of a host and the terminal machine according to the first and second embodiments and the other embodiments 1 to 9, is provided in the system or equipment, and the computer (or a CPU or an MPU) in the system or the equipment reads and executes the program code which is stored in the recording medium.

In this case, the program code itself which is read from the recording medium realizes the function of each of the embodiments and the recording medium itself recording thereon the program code or the program code recorded thereon constitutes the present invention.

As the recording medium for supplying the program code, a ROM, a flexible disk, a hard disk, an optical disk, a magneto-optical disk, a CD-ROM, a CD-R, a magnetic tape, a nonvolatile memory card, and so on can be utilized.

Furthermore, it needs not to say that such a case is included in this embodiment, where an OS and so on operating on the computer perform a part or all of the actual process based on the command of the program code and the process realizes the function of each of the embodiments, as well as a case in which the program code read by the computer is carried out to realize the function of each of the embodiments.

Moreover, such a case is of course included in the present invention, where the program code read from the recording medium is written in a memory which is provided in a function expansion board inserted in the computer or a function expansion unit connected to the computer and thereafter, the CPU and so on which are provided in the function expansion board or the function expansion unit perform a part or all of the actual process based on the command of the program code so that the process can realize the function of each of the embodiments.

According to the present invention, as described above, when the data d0, which is data to be protected and so on, is encoded using the first data d1 (the mark data) and the second data α, encoding is performed in the following manner.

Encoding is performed so that when the encode data d2, which is obtained after the data d0 is encoded, is decoded, the first data d1 is obtainable from the encode data d2 using the second data α, and based on a result of analyzing it, the definite rule which the first data d1 has can be detected (specified).

Therefore, in decoding the data X, when the first data d1 is obtainable from the data X using the second data α, and based on a result of analyzing it, the definite rule which the first data d1 has is detected, the data X is considered to be the encode data d2.

Therefore, the encode data d2 is stored in storing means, and when the data output from the storing means is monitored, based on the detection result, it can be discriminated whether the output data is the encode data d2 or not.

For example, in the case where the result (the encode data d2) of encoding the important data to be kept confidential as the data d0 is stored in the storing means and the data output from the storing means is monitored, if the output data can be recognized as the encode data d2 (the important data to be kept confidential) based on the detection result, an appropriate process corresponding to the result (process such as the communication interruption and the notification to protect the important data to be kept confidential) can be performed.

Therefore, according to the present invention, the data to be protected can surely be prevented from being taken out by the unauthorized outside access or user.

What is claimed is:

1. An encoder for encoding object data d0 using first data d1 having a definite rule and predetermined second data α, comprising
means for performing encoding so that said definite rule is detectable, when encode data d2 of said object data d0, which is obtained by encoding, is decoded, based on a result of analyzing said first data d1 obtained from said encode data d2 using said second data α.

2. The encoder according to claim 1, wherein said first data d1 includes data which is obtained by computing an optional function having a predetermined parameter ω.

3. The encoder according to claim 1, wherein encoding is performed so that said encode data d2 is obtained by computation for inserting said first data d1 into said object data d0 in units of bit using said second data α.

4. The encoder according to claim 1, wherein said first data d1 includes data which is obtained using orthogonal functions and is capable of taking different values even with the same parameter.

5. A decoder for decoding encode data d2 of object data d0 which is encoded using first data d1 having a definite rule and predetermined second data α, comprising:
obtaining means for obtaining said first data d1 from said encode data d2 using said second data α; and
detecting means for detecting said definite rule by analyzing said first data d1 which is obtained by said obtaining means.

6. The decoder according to claim 5, wherein said first data d1 includes data which is obtained by computing an optional function having a predetermined parameter ω as said definite rule, and said detecting means detects said predetermined parameter ω.

7. The decoder according to claim 5, wherein decoding is performed so that said object data d0 and said first data d1 are obtained by extracting a part from said encode data d2 in units of bit using said second data α.

8. The decoder according to claim 5, wherein said first data d1 includes data which is obtained using orthogonal functions and is capable of taking different values even with the same parameter.

9. A data processing apparatus for monitoring data output from storing means which stores at least encode data d2 of object data d0 which is encoded using first data d1 having a definite rule and predetermined second data α, comprising:
detecting means for detecting said definite rule from data sent out from said storing means by obtaining said first data d1 from said encode data d2 by using said second data α to analyze said first data d1; and
processing means for performing a predetermined process for outputting of said encode data d2 based on a result of the detection by said detecting means.

10. The apparatus according to claim 9, wherein, when said definite rule is detected, said predetermined process includes at least one of a process of interrupting a communication line which is connected to said storing means, for outputting data, and a process of giving a notification of said detection.

11. A recording medium recording thereon an encoded result of data d0, which has been encoded by an encoding function, so that said result can be sent out to a communication line, said function being for encoding optional data d0 using first data d1 having a definite rule and predetermined second data α, and being capable of detecting said definite rule on the basis of a result of an analysis of said first data d1 obtained from encode data d2 using said second data α, when said encode data d2 of said data d0, which is obtained by encoding, is decoded.

12. A network system comprising a plurality of devices which are connected to communicate with each other via a network,
wherein at least one of said devices is a device for performing encoding object data d0 using first data d1 having a definite rule and predetermined second data α, said device comprising means for performing encoding so that said definite rule is detectable, when encode data d2 of said object data d0, which is obtained by encoding, is decoded, based on a result of analyzing said first data d1 obtained from said encode data d2 using said second data α.

13. A network system comprising a plurality of devices which are connected to communicate with each other via a network,
wherein at least one of said devices is a device for decoding encode data d2 of object data d0 which is encoded using first data d1 having a definite rule and predetermined second data α, said device comprising obtaining means for obtaining said first data d1 from said encode data d2 using said second data α and detecting means for detecting said definite rule by analyzing said first data d1 which is obtained by said obtaining means.

14. A network system comprising a plurality of devices which are connected to communicate with each other via a network,
wherein at least one of said devices is a device comprising a recording medium recording thereon an encoded result of data d0, which has been encoded by an encoding function, so that said result can be sent out to a communication line, said function being for encoding optional data d0 using first data d1 having a definite rule and predetermined second data α, and being capable of detecting said definite rule on the basis of a result of an analysis of said first data d1 obtained from encode data d2 using said second data α, when said encode data d2 of said data d0, which is obtained by encoding, is decoded.

15. A data processing method for monitoring data on a communication line to which at least storing means for storing optional data is connected, comprising the steps of:
encoding predetermined object data d0 using first data d1 having a definite rule and predetermined second data α; and
storing in the storing means encode data d2 of said object data d0, which is obtained in said step of encoding,
wherein said step of encoding includes the step of performing encoding so that said definite rule is detectable, when said encode data d2 is decoded, based on a result of analyzing said first data d1 which is obtained from said encode data d2 using said second data α.

16. The method according to claim 15, further comprising the step of
decoding data on the communication line in sequence using said second data α,
wherein said step of decoding comprises the steps of obtaining said first data d1 from said object data on said communication line using said second data α and detecting said definite rule by analyzing said first data d1 which is obtained in the step of obtaining.

17. The method according to claim 16, further comprising the step of
performing a predetermined process based on a result detected in the step of detecting.

18. The method according to claim 17,
wherein, when said definite rule is detected, said predetermined process comprises at least one of a process of interrupting communication and giving a notification of said detection.

19. A computer-readable recording medium recording thereon a program for causing a computer to realize a function of monitoring data on a communication line to which at least storing means for storing optional data is connected,
wherein said program includes a program for causing said computer to execute the step of processing which includes the steps of encoding predetermined object data d0 using first data d1 having a definite rule and predetermined second data α and storing in said storing means encode data d2 of said object data d0, which is obtained in the step of encoding, and
said step of encoding includes the step of performing encoding so that said definite rule is detectable, when said encode data d2 is decoded, based on a result of analyzing said first data d1 obtained from said encode data d2 using said second data α.

20. A computer-readable recording medium recording thereon a program for causing a computer to realize a function of encoding object data d0 using first data d1 having a definite rule and predetermined second data α,
wherein said program includes a program for causing said computer to realize a function of performing encoding so that said definite rule is detectable, when encode data d2 of said object data d0, which is obtained by encoding, is decoded, based on a result of analyzing said first data d1 obtained from said encode data d2 using said second data α.

21. A computer-readable recording medium recording thereon a program for causing a computer to realize a function of decoding encode data d2 of object data d0 which is encoded using first data d1 having a definite rule and predetermined second data α,
wherein said program includes a program for causing said computer to realize a function of detecting said definite rule by obtaining said first data d1 from said encode data d2 by using said second data α to analyze said first data d1.

22. A program product for causing a computer to realize a function of monitoring data on a communication line to which at least storing means for storing optional data is connected, said program comprising:
a program for causing said computer to realize the step of processing which includes the steps of encoding predetermined object data d0 using first data d1 having a definite rule and predetermined second data α and storing in said storing means encode data d2 of said object data d0, which is obtained in the step of encoding,
wherein said step of encoding includes the step of performing encoding so that said definite rule is detectable, when said encode data d2 is decoded, based on a result of analyzing said first data d1 which is obtained from said encode data d2 using said second data α.

23. A program product for causing a computer to realize a function of encoding object data d0 using first data d1 having a definite rule and predetermined second data α,
wherein said program causes said computer to realize a function of performing encoding so that said definite rule is detectable, when encode data d2 of said object data d0, which is obtained by encoding, is decoded, based a result of analyzing said first data d1 obtained from said encode data d2 using said second data α.

24. A program product for causing a computer to realize a function of decoding encode data d2 of object data d0 which is encoded using first data d1 having a definite rule and predetermined second data α,
wherein said program causes said computer to realize a function of detecting said definite rule by obtaining said first data d1 from said encode data d2 by using said second data α to analyze said first data d1.
